(19) United States
(12) Patent Application Publication
(10) Pub. No.: US 2003/0090377 A1
(43) Pub. Date: May 15, 2003

(54) INFRA-SOUND SURVEILLANCE SYSTEM

(76) Inventor: Norbert Pieper, Olfen (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/986,604

(22) Filed: Nov. 9, 2001

(51) Int. Cl. G08B 13/00

(52) U.S. Cl. 340/566; 367/93; 340/565

(57) ABSTRACT

The invention is a method for monitoring an environment by evaluating an infrasonic signal obtained from said environment. The method includes averaging said infrasonic signal (V_{infra}) to provide an averaged infrasonic signal (Vₐᵥ), mapping said averaged infrasonic signal (Vₐᵥ) according to a function to provide an infrasonic noise signal (Vₙₒᵢₛₑ); averaging said infrasonic noise signal (Vₙₒᵢₛₑ) to provide an averaged infrasonic noise signal (V_{av noise}); offsetting said averaged infrasonic noise signal (V_{av noise}) with an offset value to provide an infrasonic level signal (Vₗᵢₘᵢₜ); comparing said infrasonic level signal (Vₗᵢₘᵢₜ) with said averaged infrasonic signal (Vₐᵥ); and generating a trigger signal (30) if said averaged infrasonic signal (Vₐᵥ) is greater than said infrasonic level signal (Vₗᵢₘᵢₜ).

The present invention relates to a method, a module, a device, a module and a system for detecting an environment noise by evaluating an infrasonic signal. Particularly, the method according to the present invention provides a continuous level adjustment algorithm to adapt the detection level to a noise background for evaluating the infrasonic signal, for example to monitor a certain ambiance or environment.

Sound frequencies in a frequency range of about 0.1 Hz up to 20 Hz are normally designated as infra-sound. Infra-sound or an infrasonic pulse is generated by small changes of the air pressure, respectively. Such small changes of the air pressure may be generated by opening or closing of a door or a window but even by persons moving though a room. Due to the object surfaces moving through the air small changes of the air pressure are released such that infrasonic pulses are emitted by the respective moving object. These infrasonic pluses or infra-sound may by detected in a radius of up to 50 m away from the emerging object. But the radius of detection is further dependent on background noise and the space within which the infra-sound is propagating.

To detect infra-sound special microphones are used. These microphones are adapted to detect low frequency sound since low frequency sound is additionally often of low amplitude or low power, respectively. Nevertheless, microphones able to detect infra-sound (about 0.1 Hz to 20 Hz) and speech (about 200 Hz to 15 kHz) are available at reliable detection sensitivity.

A couple of detector systems and devices are in use to protect environments, rooms, homes, buildings and cars from being accessed in an unauthorised way. The mainly used detectors are ultrasonic motion detectors, infra-red detectors, light barriers and the like. These detectors may be combined with an alarm system in order to secure a respective object. Also infra-sound detectors are able to monitor a space signalising an opening of a door or a window or even a motion within the monitored space. Such infra-sound detectors are well known and used in motor vehicles to trigger an alarm system for example to prevent burglary of the motor vehicles.

Applications are known where separate infra-sound detecting devices are connected to a mobile phone, like described in WO 99/53456. These infra-sound detecting devices are used to trigger or rise any kind of alarm or monitoring action.

Normally, special infra-sound detecting microphones are used for detecting infra-sound events. These infra-sound microphones are expensive and require the implementation of a separate infra-sound microphone. The usage of microphones detecting sound in a wide frequency range covering infra-sound frequencies and voice/speech frequencies enables to extend the devices processing voice/speech audio signals to an alarm system by operating these devices to evaluate infrasonic signals detected by the microphones.

An object of the invention is a method for monitoring an environment by evaluating an infrasonic signal taking a sound of said environment. The object is attained by claim 1 and accompanying dependent claims.

Another object of the invention is a module of a surveillance system for monitoring the environment by evaluating an infrasonic signal. The object is attained by claim 16 and accompanying dependent claims.

A further object of the invention a device of a surveillance system for monitoring by evaluating an infrasonic signal. The object is reached by claim 20 and accompanying dependent claims.

Yet another object of the invention a system of a surveillance system for monitoring by evaluating an infrasonic signal. The object is reached by claim 25 and accompanying dependent claims.

Usually, infra-sound detection systems, especially used in combination with alarm systems, employ fixed detection levels. The detection level defines an infra-sound level, normally an infra-sound amplitude level, at which a detected infra-sound event is interpreted as event to be signalised for example by an alarm of the alarm system. The fixed detection level is often adjustable to the environmental noise background but the environmental noise background can change due to outer effects. For example, while monitoring the infra-sound within a motor vehicle the monitored infra-sound background level is depending on the place where the motor vehicle is parked. Near a heavily used road the infra-sound background level may be higher than within a residential area. That means, that in case of a low detection level a lot of false alarms are triggered or in case of a high detection level a careful opening of a door might be unnoticed. Both cases are undesired.

Therefore, a continuous level adjustment algorithm provides the possibility to pre-determine a detection level which is continuously adapted to the background level. The number of false alarm of an alarm system which uses this algorithm to evaluate measured infra-sound can be reduced while the overall sensitivity of the infra-sound event detection is quite low and hence reliable.

According to a first aspect of the invention a method of a surveillance system for monitoring by evaluating an infrasonic signal is provided. An infrasonic signal is averaged to yield an averaged infrasonic signal. The averaged infrasonic signal is mapped according to a function to yield an infrasonic noise signal. This infrasonic noise signal is averaged to yield an averaged infrasonic noise signal. By offsetting the averaged infrasonic noise signal with an offset value an infrasonic level signal is provided. This infrasonic level signal is compared with the averaged infrasonic signal. According to the comparison if the averaged infrasonic signal is greater than the infrasonic level signal a trigger signal is generated.

The infrasonic signal may be provided by filtering. The filtering may be employed on signals comprising infrasonic signals and non-infrasonic signals, i.e. signals of non-infrasonic frequency. Hence, the characteristic of the filtering may be limited to an infrasonic frequency range. The filtering may be a band-pass filter employed to extract an infrasonic signal. The band-pass filter characteristic may be limited to an infrasonic frequency range. A low-pass filter may also be employed for extracting the infrasonic signal. Accordingly, the low-pass filter characteristic may be limited to an infrasonic frequency range.

The averaged infrasonic signal may be a root mean square infrasonic signal. But also further averaging methods may be employed on the infrasonic signal to yield the averaged infrasonic signal.

The mapping of the averaged infrasonic signal may also comprise an additional rating of the function result with the averaged infrasonic noise signal. The function for mapping may be a non-linear function. This function may be used for weighting an additional rating signal, especially the averaged infrasonic noise signal. The function argument may by the result of an arbitrary combination of the averaged infrasonic signal and the averaged infrasonic noise signal. Particularly, the argument may be the result of the division of the averaged infrasonic signal and the averaged infrasonic noise signal. Moreover, the function may map the result the division of the averaged infrasonic signal and the averaged infrasonic noise signal to provide a function result and this function result may be multiplied with the averaged infrasonic noise signal to provide the infrasonic noise signal.

The offset value may be an absolute offset value, increasing the averaged infrasonic noise signal by a constant absolute value. The offset value may be a relative offset value. The increasing offset of the averaged infrasonic noise signal is determined relatively to the averaged infrasonic noise signal. Further, the offset value may be multiplied with the averaged infrasonic noise signal to provide the infrasonic level signal. Particularly, the offset value may be defined by a signal-to-noise ratio (SNR). Moreover, the offset value may be adjustable to adapt the evaluation method to different operating conditions.

According to another aspect of the invention a software tool of a surveillance system for monitoring by evaluating an infrasonic signal is provided. The software tool comprises program potions for carrying out the operations of the aforementioned methods of a surveillance system for monitoring by evaluating an infrasonic signal when the software tool is implemented in a computer program and/or executed on a computer, a processing device or a digital signal processing device.

According to another aspect of the invention a computer program of a surveillance system for monitoring by evaluating an infrasonic signal is provided. The computer program comprises program potions for carrying out the operations of the aforementioned methods of a surveillance system for monitoring by evaluating an infrasonic signal when the software tool is implemented in a computer program and/or executed on a computer, a processing device or a digital signal processing device.

According to another aspect of the invention a computer program product is provided which comprises program code portions stored on a computer readable medium for carrying out the aforementioned methods of a surveillance system for monitoring by evaluating an infrasonic signal when said program product is executed on a computer, a processing device or a digital signal processing device.

According to another aspect of the invention a module of a surveillance system for monitoring by evaluating an infrasonic signal is provided. The module comprises a first averaging component for averaging the signal to provide an averaged infrasonic signal, a mapping component for mapping the averaged infrasonic signal according to a function to provide an infrasonic noise signal, a second averaging component for averaging the infrasonic noise signal to provide an averaged infrasonic noise signal, an offsetting component for offsetting the averaged infrasonic noise signal with an offset value to provide an infrasonic level signal, a comparing component comparing the infrasonic level signal with the averaged infrasonic signal and a generating component generating a trigger signal if the averaged infrasonic signal is greater than the infrasonic level signal.

The module may also comprise a filter component for filtering the infrasonic signal. The filter component may be employed on signals comprising infrasonic signals and non-infrasonic signals, i.e. signals of non-infrasonic frequency. For filtering the infrasonic signal the filter component characteristic may be limited to an infrasonic frequency range. It may be possible to employ a band-pass filter or a low-pass filter on the infrasonic signal.

The averaging component may be a root mean square averaging component to provide a root mean square infrasonic signal as averaged infrasonic signal.

The mapping of the averaged infrasonic signal may also comprise an additional rating of the function result with the averaged infrasonic noise signal. Therefore, the module may also comprise a rating component for rating the function with the averaged infrasonic noise signal. The function for mapping may be a non-linear function. This function may be used for weighting an additional rating signal, especially the averaged infrasonic noise signal. The function argument may by the result of an arbitrary combination of the averaged infrasonic signal and the averaged infrasonic noise signal. Particularly, the argument may be the result of the division of the averaged infrasonic signal and the averaged infrasonic noise signal. Therefore, the module may comprise a dividing component for the averaged infrasonic signal and the averaged infrasonic noise signal. Moreover, the function may map the result the division of the averaged infrasonic signal and the averaged infrasonic noise signal to provide a function result and this function result may be multiplied with the averaged infrasonic noise signal to provide the infrasonic noise signal.

The offset value may be an absolute offset value, increasing the averaged infrasonic noise signal by a constant absolute value. The offset value may be a relative offset value. The increasing offset of the averaged infrasonic noise signal is determined relatively to the averaged infrasonic noise signal. Further, the offset value may be offset by multiplying with the averaged infrasonic noise signal to provide the infrasonic level signal. Particularly, the offset value may be defined by a signal-to-noise ratio (SNR). Moreover, the offset value may be adjustable to adapt the evaluation method to different operating conditions.

According to another aspect of the invention a device of a surveillance system for monitoring by evaluating an infrasonic signal is provided. The device comprises a detector to detect sound waves, a processing unit and components responsive to a trigger signal. The detector is adapted to a sound wave frequency range including an infrasonic frequency range. The processing units executes the operation of the aforementioned method of a surveillance system for monitoring by evaluating an infrasonic signal and the infrasonic signal is provided by the detector. The trigger signal is generated according to the aforementioned method and initiates operations and functions of the device. The detector signals may have to be filtered to extract infrasonic signals out of the detector signals.

The detector able to detect infrasonic signals may be a microphone. The microphone may be adapted to an infrasonic frequency range. Further, the microphone may be adapted to an infrasonic frequency range and a frequency range of audio signals occurring in voice or speech.

The device may be a mobile phone. The mobile phone may be a mobile phone built-in a motor vehicle. Mobile phones include digital signal processing units to operate on voice signals of the user. These digital processing units may also operate the evaluation of the infrasonic signals. Therefore, it may be necessary that each mobile phones provide microphones which are able to detect both infrasonic signals and voice/speech signals.

The device may be a voice/speech controlled device. Device functions of such devices may be controlled by spoken commands. Therefore, the devices may each have to comprise a voice signal processing unit. This voice signal processing unit may also operate the evaluation of the infrasonic signals. Therefore, it may be necessary that the devices include microphones which are able to detect both infrasonic signals and voice/speech signals.

According to another aspect of the invention a system of a surveillance system for monitoring by evaluating an infrasonic signal is provided. The system comprises a module according to the aforementioned module of a surveillance system for monitoring by evaluating an infrasonic signal and a device processing voice/speech signals and infrasonic signals. This device comprises a detector to detect sound waves and components responsive to a trigger signal. The detector is adapted to a sound wave frequency range including an infrasonic frequency range. The trigger signal is provided by the module. The detector signals may have to be filtered to extract infrasonic signals out of the detector signals.

The detector able to detect infrasonic signals may be a microphone. The microphone may be adapted to an infrasonic frequency range. Further, the microphone may be adapted to an infrasonic frequency range and a frequency range of audio signals occurring in voice or speech sound signals.

The device may be a mobile phone. The mobile phone may be a mobile phone built-in a motor vehicle. Mobile phones include digital signal processing units to operate on voice signals of the user. These digital processing units may also operate the evaluation of the infrasonic signals. Therefore, it may be necessary that the mobile phones provide microphones which are able to detect both infrasonic signals and voice/speech signals.

The device may be a voice/speech controlled device. Device functions of such devices may be controlled by spoken commands. Therefore, the devices may each have to comprise a voice signal processing unit. This voice signal processing unit may also operate the evaluation of the infrasonic signals. Therefore, it may be necessary that the devices include microphones which are able to detect both infrasonic signals and voice/speech signals.

The invention will now be described in more detail with reference made to the accompanying drawings, in which:

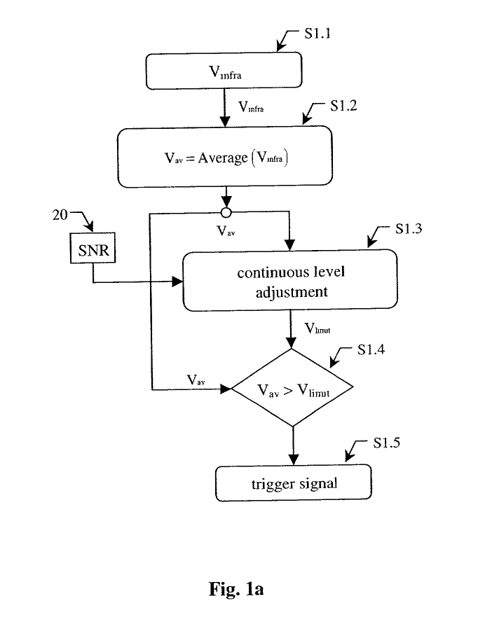

FIG. 1a shows a flow diagram of the operations for evaluating an infrasonic signal according to an embodiment of the invention,

FIG. 1b shows a flow diagram of the continuous level adjustment algorithm according to FIG. 1a,

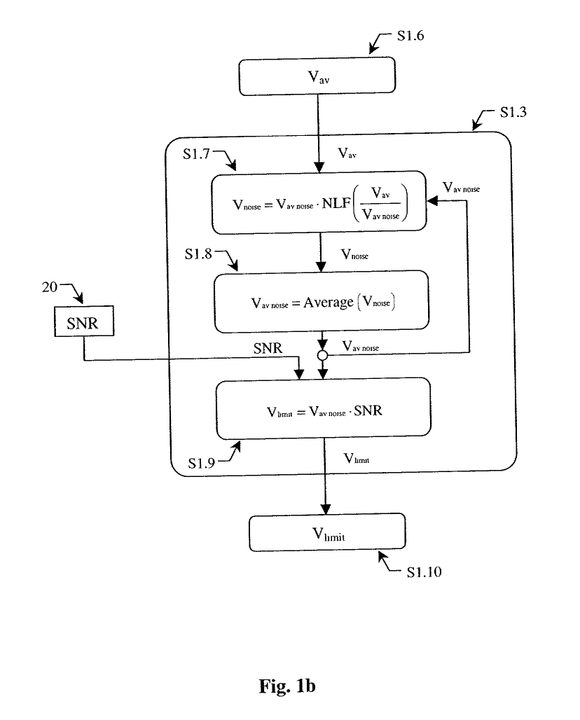

FIG. 2 shows a plot illustrating a non-linear function according to the continuous level adjustment algorithm with respect to an embodiment of the invention,

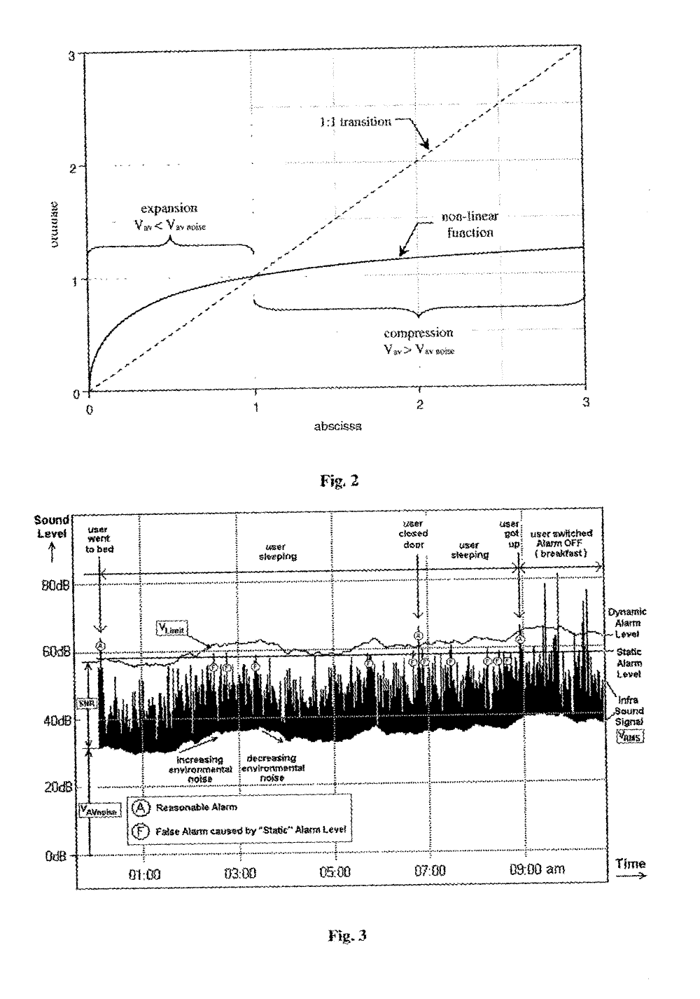

FIG. 3 shows a time plot of an infra-sound measurement illustrating the evaluation according to the continuous adjustment algorithm with respect to an embodiment of the invention,

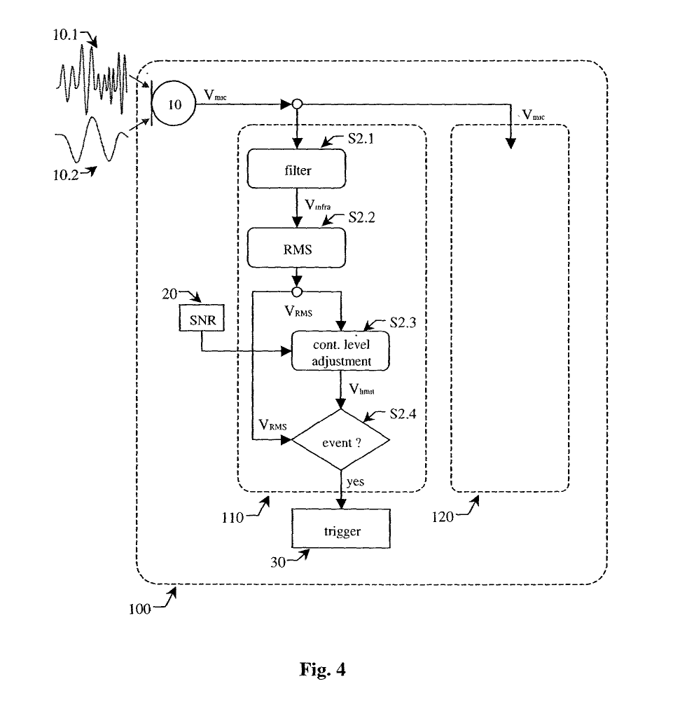

FIG. 4 shows a schematic diagram of audio signal processing device equipped with a microphone and extended to evaluate an infrasonic signal according to an embodiment of the invention and

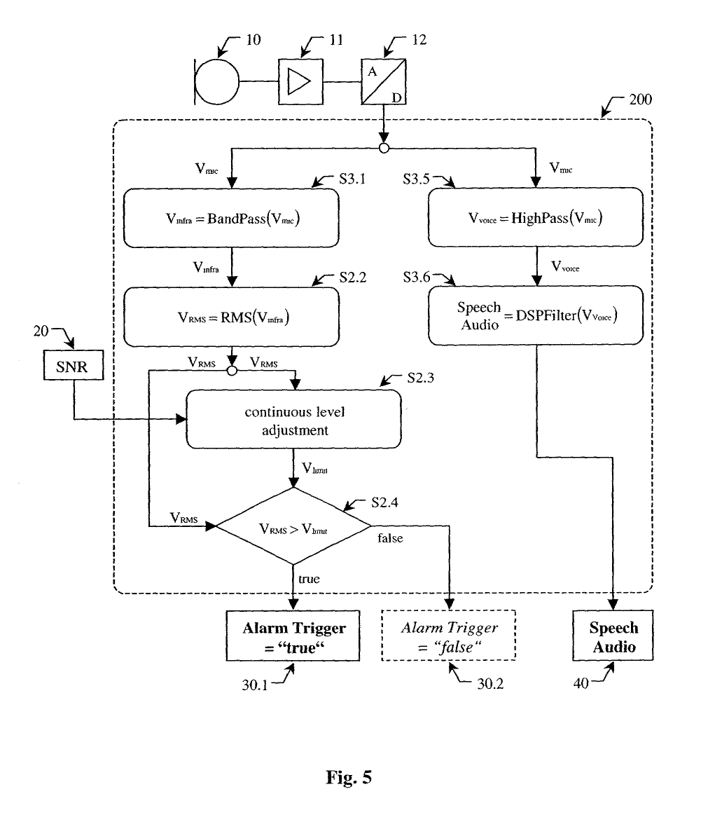

FIG. 5 shows an implementation of the infra-sound detection device within a digital signal processor of a mobile phone with respect to an embodiment of the invention and

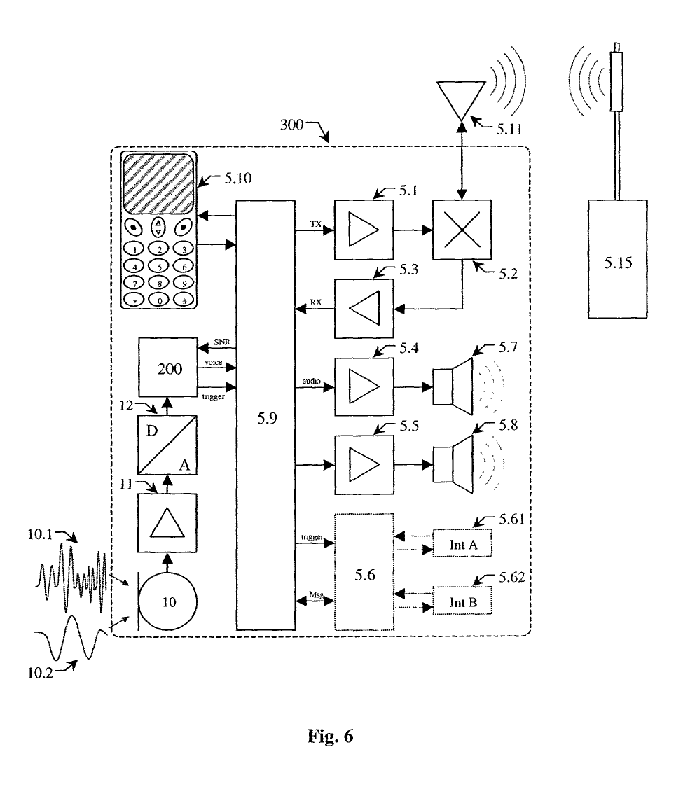

FIG. 6 shows a mobile phone with implemented infra-sound detection according to an embodiment of the invention.

Same or equal parts shown in the figures will be referred by the same reference numerals.

The evaluation process of the infrasonic signals provides the possibility to extract infrasonic signals out of the noise background or environmental noise. Since the infrasonic signals may be measured signals background noise is always present within the measured signals. For example, especially in case of the utilisation of an infrasonic detector for monitoring a certain space, like a room of a spacious interior of a motor vehicle or a building a lot of infrasonic signals are detected. The extraction of conspicuous infrasonic signals provide the possibility to monitor effectively a spacious interior which means that the number of false event detection is as small as possible and only reasonable events are reported.

The evaluation process is based on a suitable algorithm for extracting infrasonic signals. The evaluation process distinguishes itself by a continuous adaptation of a noise level determined for the infrasonic signal. This adaptation enables to extract infrasonic signals even if the noise background is changing in time.

An additional provided offset value may define and provided to the continuous level adjustment. The continuous level adjustment determines an averaged infrasonic noise level representing the an averaged value of the background noise which is included in the infrasonic signal. A threshold value may be determined based on the offset value and the averaged infrasonic noise signal. The threshold level may be used for evaluating an infrasonic signal by comparing, i.e. infrasonic signals greater than the threshold value may be extracted infrasonic signals of relevant values or strength by the evaluation process, respectively, which enables to generate a trigger in combination with this extraction process.

FIG. 1a shows a flow diagram of the operations for evaluating an infrasonic signal according to an embodiment of the invention.

In an operation S1.1 an infrasonic signal V_{infra} is provided. The infrasonic signal V_{infra} may be a signal of an infra-sound detector. The infra-sound detector may be a microphone adapted to frequencies out of the infrasonic frequency range.

It may also be possible to obtain the infrasonic signal from a microphone adapted to frequencies out of the infrasonic frequency range and audio frequencies. Most standard microphone adapted to audio frequencies and used for detecting audio signals have the possibility to detect infrasonic signals. The sensitivity of these microphones in the frequency range of infra-sound may be lower since these microphone are not optimised for detecting infra-sound but may even enable to obtain and evaluate the infrasonic signals. It may be necessary to amplify the signals using an adapted suitable amplifier.

Further it may be necessary to filter the infrasonic signals. Particularly in case of using microphones adapted to a wide frequency range covering non-infrasonic frequencies an adapted filtering may have to be employed. Due to the kind of detector used for obtaining the infrasonic signals, a band-pass filter or a low-pass filter may be employed on the signals of the detector to obtain suitable infrasonic signals which can be evaluated according to an embodiment of the present invention. The characteristic of the filter may have to be adapted to the infrasonic frequency range or a part thereof.

In an operation S1.2 the infrasonic signal V_{infra} may be averaged. The averaging may be any kind of averaging method. Further, a root mean square averaging may be possible. The averaging procedure results in an averaged infrasonic signal Vₐᵥ.

In an operation S1.3 an infrasonic level signal Vₗᵢₘᵢₜ is obtained from the averaged infrasonic signal Vₐᵥ. The averaged infrasonic signal Vₐᵥ is obtained according to the continuous level adjustment (FIG. 1b). The continuous level adjustment provides a method to obtain an adapted noise level of a noise background of the infrasonic signal, which means that the adapted noise level is always adapted to the noise background even if the noise background is changing on a certain time scale. This adapted noise level is rated with an additional offset value which is provided to the continuous level adjustment. The adapted noise level may be rated with this additionally provided offset value to provide the infrasonic level signal.

The adapted noise level may represent a kind of mean noise background level with respect to a certain time scale. The rating of the adapted noise level with the offset value may be understood as increasing the adapted level by an offset value to obtain the infrasonic level signal Vₗᵢₘᵢₜ. Thus the infrasonic level signal Vₗᵢₘᵢₜ defines a level signal which extends timely parallel to a noise background adapted level offset by an additional offset value.

The additional offset value is adjustable to define the sensitivity of the evaluation of the infrasonic signal. The adjustability provides the possibility to select an offset value according to the application. Referring again to the above mentioned example, in case of monitoring a spacious interior of a motor vehicle the background noise is more intensive and more varying on a short and long time scale as in case of monitoring a spacious interior of a building. A noise background varying on a long time scale is covered by the above described continuous level adjustment. A noise background varying on a short time scale may be covered by an adjusted offset value.

The offset value may be an absolute offset value.

The offset value may define a relative offset value, i.e. the adapted noise level is offset by an offset value which is relative to the adapted noise level according to the offset value to provide the infrasonic noise signal Vₗᵢₘᵢₜ. Further, that means that the higher the noise background the higher the offset value, whereas the offset value is small in case of a small noise background.

It may be possible to provide a signal-to-noise ratio (SNR) 20 as the offset value to the continuous level adjustment. A SNR 20 is a relative value, i.e. the SNR 20 may be a factor with which the adapted noise level is rated or multiplied, respectively. A signal-to-noise ratio is a value known to those skilled in the art for defining usually a minimal signal level with respect to the noise background at which signal may be properly distinguished and evaluation of signals may be meaningful.

In an operation S1.4 the averaged infrasonic signal Vₐᵥ and the infrasonic level signal Vₗᵢₘᵢₜ are compared. If the averaged infrasonic signal Vₐᵥ is greater than the infrasonic level signal Vₗᵢₘᵢₜ a trigger signal may be initiated. It may also be possible to initiate a trigger signal if the averaged infrasonic signal Vₐᵥ is grater than or equal to the infrasonic level signal Vₗᵢₘᵢₜ.

It may be possible to provide a pre-defined trigger signal in order to control further operations, devices, units or functions which may be operated in case of a trigger event. Further it may also be possible to provide the averaged infrasonic signal Vₐᵥ itself as trigger signal which may be processed by further operations, devices, units or functions.

The continuous level adjustment algorithm is used to determine a threshold level, namely infrasonic level signal Vₗᵢₘᵢₜ, will be described in more details. The continuous level adjustment may allow to determine an averaged infrasonic noise signal which corresponds to the background noise or environmental noise of the infrasonic signal, respectively.

The origin of the noise background may be reduced to different noise sources. One of the sources may be infrasonic background signals detected and determined by the infrasonic detector. These signals may are based on physical processes in the detection space of the infrasonic detector. Moreover also infrasonic signals which may be traced back to dedicated events but which may not wished to be detected and evaluated may be also termed as background noise. Further, the infrasonic detector may generate itself infrasonic signal due to the detection method or process, respectively, known to all detectors based on physical measurement processes. Also, interposed signal processing components may modify or contribute to the background noise.

The enumeration of the background sources described above may not be complete. Further background generating processes may be involved and contribute in any way to the complete background noise or background signal, respectively, known to those skilled in the art.

The continuous level adjustment may also compensate sensitivity differences of infrasonic detectors and components processing the obtained infrasonic signals by the infrasonic detector and interposed between infrasonic detector and evaluation process of the infrasonic signals. These components, not limiting, may be signal amplifiers, signal filters and the like. Properties of detectors as also signal processing components may vary within the series. This may lead to an overall different signal sensitivity due to the variation and/or to different background noise contributions. The continuous level adjustment according to an embodiment of the present invention may be able to compensate such effects and allow to evaluate infrasonic signals in a comparable way by different implementations of the signal evaluation process in case of using components with varying properties.

FIG. 1b shows a flow diagram of the continuous level adjustment algorithm according to FIG. 1a. Further, additional references to FIG. 1a will be provided to enlighten broadly the method for evaluating an infrasonic signal with respect to an embodiment of the invention.

In an operation S16 an averaged infrasonic signal Vₐᵥ is provided. According to the FIG. 1a This signal is provided by operation S1.2.

The following operations S1.7, S1.8 and S.19 may describe the continuous level adjustment referred as operation S1.3 in FIG. 1a in detail.

In an operation S1.7 an infrasonic noise signal V_{Noise} is determined from an averaged infrasonic noise signal V_{av noise} representing the level of the infrasonic background noise and the averaged infrasonic signal Vₐᵥ. A non-linear weighting function (NLF) may be employed to weight the averaged infrasonic signal in comparison to the averaged infrasonic noise signal V_{av noise}. The result of the non-linear weighting function (NLF) is used for rating the averaged infrasonic noise signal V_{av noise}, i.e. if the averaged infrasonic signal Vₐᵥ is equal to the averaged infrasonic noise signal V_{av noise} the values of the averaged infrasonic noise signal V_{av noise} may be assigned unmodified to the infrasonic noise signal V_{Noise}. In case of an averaged infrasonic signal Vₐᵥ greater than the averaged infrasonic noise signal V_{av noise} a value which is greater than the value of the averaged infrasonic noise signal V_{av noise} may be assigned to than infrasonic noise signal V_{Noise}. Further, in case of an averaged infrasonic signal Vₐᵥ smaller than the averaged infrasonic noise signal V_{av noise} a value which is smaller than the value of the averaged infrasonic noise signal V_{av noise} may be assigned to than infrasonic noise signal V_{Noise}.

The result of the operation S1.7 may be denoted mathematically by following term:

$${V}_{Noise} = {V}_{AV Noise} \cdot NLF ( \frac{{V}_{AV}}{{V}_{AV Noise}} )$$

wherein the function NLF may be defined as follows:

$$NLF ( x ) = \{ \begin{matrix}y > x & \text{for} 1 \leq x < 1 \\ 1 & \text{for} x = 1 \\ y < x & \text{for} 1 < x\end{matrix}$$

This definition of the non-linear function NLF may fulfil the weighting of the averaged infrasonic noise signal in an adequate way.

In an operation S1.8 the infrasonic noise signal Vₐᵥ is averaged by a suitable and adapted averaging method to provide the averaged infrasonic noise signal V_{av noise}. The averaging method may be a timely averaging to reduce variations in the infrasonic noise signal Vₐᵥ since it is assumed that processes changing the signal strength of the background noise are occurring on a time scale which is longer than the time scale of processes generating infrasonic signals which are desired to be extracted in order to initiate the trigger as a result of the comparison operation in operation S1.5 in FIG. 1a. The operation may provide the averaged infrasonic noise signal V_{av noise}.

It may be noted that the continuous level adjustment according to an embodiment of the present invention is an iterative method for obtaining an averaged infrasonic noise signal V_{av noise}. In the beginning the averaged infrasonic noise signal is unknown in the operation S1.7 since this signal may be provided by operation S1.8 for the first time. A suitable adapted initial signal value assigned to the unknown averaged infrasonic noise signal V_{av noise}, for example the averaged infrasonic signal value (Vₐᵥ) may be assigned to the averaged infrasonic noise signal V_{av noise}, and a suitable adapted defined non-linear function NLF may ensure that the continuous level adjustment converge against an averaged infrasonic noise signal Vₐᵥ noise representing the averaged value of the background noise signals.

In an operation S1.9 the averaged infrasonic noise signal V_{av noise} may be rated with an offset value to provide the infrasonic level signal Vₗᵢₘᵢₜ. The offset value may be an absolute offset value increasing the averaged infrasonic noise signal V_{av noise} by a constant offset value. Further the offset value may be a relative offset value increasing the averaged infrasonic noise signal V_{av noise} by a relative offset value according to the value of the averaged infrasonic noise signal V_{av noise}.

According to an embodiment of the invention a signal to ratio value (SNR) 20 may provided as offset value. SNR values are known to those skilled in the art for defining signal values and levels in respect to background noise of the respective signal. The infrasonic level signal Vₗᵢₘᵢₜ may be based on the SNR value 20 and on the averaged infrasonic noise signal V_{av noise} according to the following mathematical term:

V_{Limit}=V_{AV Noise}·SNR

An additional pre-defined offset value of the continuous level adjustment may allow to adapt the continuous level adjustment to different operating conditions associated with different background noise processes. The fluctuations of the background signals may be of different magnitude and an adjustable offset value may allow to adapt to this fluctuations in the background noise.

In an operation S1.10 the provided infrasonic level signal may be provided to further operations and processing functions. According to an embodiment of the invention and with respect to FIG. 1a the infrasonic level signal Vₗᵢₘᵢₜ is provided to operation S1.4 to be compared with the averaged infrasonic signal for evaluating Vₐᵥ and generating of a trigger signal depending on the comparison result of operation S1.4 in FIG. 1a.

The presented mathematical terms may not be limiting. These terms are provided to enlighten the scope and the virtue of the continuous level adjustment. According to the basic idea of the continuous level adjustment further embodiments may be suitable.

A non-linear function NLF according to the above described definition of the non-linear function will be given in the following FIG. 2. This plotted non-linear function NLF is an exemplary non-linear function out of a plurality of possible non-linear functions which fulfil the given definition.

FIG. 2 shows a function plot illustrating a non-linear function according to the continuous level adjustment algorithm with respect to an embodiment of the invention.

The plot depicts a function x=y, denoted as 1:1 transition, and a non-linear function suitable for operating in the continuous level adjustment like described above. The argument of the functions is plotted on the horizontal axis or abscissa, respectively, whereas the results of the functions is plotted on the vertical axis or ordinate, respectively. Both axis show a value range of 1 to 3.

Referring back to operation S1.7 shown in FIG. 1b, the argument of the non-linear function is a quotient of the averaged infrasonic signal Vₐᵥ and the averaged infrasonic noise signal V_{av noise}, i.e. the ratio of the current evaluated signal and the averaged signal noise. Argument between 0 and 1 means that the current signal is smaller as the obtained averaged noise of the infrasonic signal, whereas an argument greater than 1 means accordingly that the current infrasonic signal is higher as the obtained averaged noise of the infrasonic signal. The first-mentioned argument range may be denoted as expansion range and the last-mentioned argument range may be denoted as compression range.

The function x=y or 1:1 transition assigns the arguments unmodified to the function values, respectively. Hence, the value of functions depicted above this 1:1 transition are greater than the value of its respective arguments. Accordingly, the value of functions depicted above this 1:1 transition are smaller than the value of its respective arguments. Consequently, the naming “expansion range” and “compression range” may be understood since the non-linear function is depicted above and below the 1:1 transition, respectively.

Employed on the method according to an embodiment of the invention that means that an averaged infrasonic signal Vₐᵥ which is smaller than the averaged infrasonic noise signal V_{av noise} is amplified whereas an averaged infrasonic signal Vₐᵥ which is greater that the averaged infrasonic noise signal V_{av noise} is reduced. First and foremost, a small slope of the non-linear function within the compression range reduces considerably high infrasonic signals so that these infrasonic signals do not affect significantly the determination of the averaged infrasonic noise signal. The non-linear function may be used as a weighting non-linear function of the current infrasonic signal with respect to the averaged infrasonic noise signal.

Summarising the most important points:

low volume signal are enhanced, high volume signals, especially high peak signals are strongly suppressed,

even extremely high peak of the infrasonic signal will not have any impact in a way that the generated averaged noise signal will be increased significantly,

using the non-linear weighting function allows the use of a relatively short time for determining the average of the noise signal,

the continuous level adjustment is able to adapt relatively quick to changing noise background without being affected by high signal peaks.

The definition of the non-linear function is free. A concrete function term has to fulfil the conditions of the expansion range and the compression range. Further conditions are not made to the non-linear function. The concrete slope of the non-linear function may be adapted to a special embodiment of the invention with respect to the conditions under which infrasonic signals are obtained for a following evaluation.

In the following an exemplary measurement employing the above described method for evaluating an infrasonic signal will be illustrated. Therefore, an embodiment according to the method for evaluating an infrasonic signal may be implemented to monitor a sleeping room and to realise a monitoring alarm system. The monitoring is carried out in a user's sleeping room from approximately 12 p.m. at the evening to 10 a.m. at the next morning. Different signals according to the embodiment of the invention are described.

FIG. 3 shows a time plot of an infra-sound measurement illustrating the evaluation according to the continuous adjustment algorithm with respect to an embodiment of the invention.

The exemplary measurement of infrasonic signals and the corresponding averaged infrasonic noise signal V_{av noise}, infrasonic level signal Vₗᵢₘᵢₜ during the monitoring process are depicted in FIG. 3. The abscissa shows the time at which the signals are measured and obtained, respectively. The ordinate shows the value of the signals depicted as decibel units. Signal values below the averaged infrasonic noise signal V_{av noise} are not plotted, only signal values above this value are plotted in FIG. 3.

The slope of the averaged infrasonic noise signal V_{av noise} represents the noise background, denoted as environmental noise herein. It may be seen that the continuous level adjustment provides a suitable method the determine the noise background of an infrasonic signal measurement. This noise background varies over the measurement time and the averaged infrasonic noise signal V_{av noise} follows accordingly these variations.

The infrasonic level signal Vₗᵢₘᵢₜ may be obtained by offsetting the averaged infrasonic noise signal V_{av noise} with an offset value, herein a signal-to-noise ration SNR is employed for offsetting the averaged infrasonic noise signal V_{av noise}.

The single tips of the plotted infrasonic peaks represent the averaged infrasonic signals Vₐᵥ, herein a root mean square averaging is performed to provide the averaged infrasonic signals Vₐᵥ in the following denoted as root mean square infrasonic signals V_{RMS}. root mean square infrasonic signals V_{RMS} within the band limited by the averaged infrasonic noise signal and the infrasonic level signal may not initiate a trigger signal since these signals are smaller than the infrasonic level signal.

The alarm system is switched on with the beginning of the signal recording of the plot in FIG. 3. Signals indicated with an indicator A may reference infrasonic signal above the infrasonic level signal. Accordingly, these signals may have initiated a generation of a trigger signal. The alarm system may indicate a significant monitoring signal on such a trigger signal and may rise alarm. Three events are indicated. The first significant signal indicated with the indicator A coincidences the event that the user went to bed. This procedure has generated an infrasonic signal, due to moving a door, which was detected by the alarm system. The second event shows an infrasonic signal which was generated by closing a door and the third event shows an event when the user got up. Other significant infrasonic signals had not passed the infrasonic level signal and were therefore not evaluated as significant signals.

In order to compare an embodiment according to the invention with an infrasonic monitoring system of state of the art a second static alarm level is provided and an infrasonic signal evaluation is carried out according to this static alarm level. Static alarm level means that a constant infrasonic level signal is used for evaluating the measured infrasonic signals wherein the static alarm level is not adapted to the changing background. The static alarm level may be seen as a horizontal line in the plot of the measured infrasonic signal. Single signals which may have initiated an alarm due to passing the static alarm level are indicated by indicator F. These events are false alarm events due to the dynamic alarm level which corresponds to the infrasonic level signal obtained by the continuous level adjustment.

Accordingly, the employment of a background adjusted infrasonic level signal for evaluating infrasonic signals is advantageous since false alarm event may be prevented. Alarm systems have to be reliable. The more false alarm events are generated by the alarm system the more alarm events are ignored even if the alarm event are reasonable. A rising background noise may initiate a lot of false alarm events in case of a static alarm level.

An embodiment according to the invention determines the average infrasonic noise signal V_{av noise} and multiplies that signal with a sufficient application specific signal-to-noise ratio SNR. For example a ratio of 6 dB may be a sufficiently best specific noise to signal ratio for monitoring a single room of a building/house whereas a ratio of 18 dB may be a sufficiently best specific noise to signal ratio for monitoring a spacious interior of a motor vehicle.

Another advantage of an embodiment according to the method of the invention may be that a background adapted alarm level may be effectively smaller than a static alarm level, since a static alarm level may be set to a static level which ensures that the number of false alarms is as small as possible. Therefore, the users of alarm system employing static alarm levels often take more likely a risk of a higher alarm level and thereupon of undetected events. The continuous level adjustment allows to overcome this problem.

An embodiment according to the invention may comprise an infrasonic detector to obtain infrasonic signals and an implementation of the method for evaluating infrasonic signals thereof. Infrasonic detectors may be adapted to an infrasonic frequency range or a part of an infrasonic frequency range according to the application of the embodiment. The infrasonic frequency range may cover a frequency range of approximately 0.2 Hz to 20 Hz. This frequency range may not be covered completely by the infrasonic detectors, for example a frequency range of 2 Hz to 20 Hz may be suitable for monitoring systems like alarm systems.

Moreover, microphones may be suitable detector devices for detecting infrasonic signals. Even voice or audio microphones may be used as infrasonic detectors. The sensitivity of such adapted microphones may have to be increased by suitable amplifying the obtained signals. An implementation of an infrasonic detection system in combination with an evaluation unit according to an embodiment of the present invention will be described in the following figures.

FIG. 4 shows a schematic diagram of audio signal processing device equipped with a microphone and extended to evaluate an infrasonic signal according to an embodiment of the invention. A signal processing device 100 may be provided. The device 100 may comprise a microphone 10 adapted to detect infrasonic signals 10.2 and audio signal 10.1, especially voice signals. The obtained signal V_{mic} may be passed to an evaluation unit 110 for evaluating the infrasonic signals. The infrasonic signal may have to be extracted from the audio signal V_{mic} due to the wide frequency range of the microphone 10.

In an operation S2.1 the audio signals V_{mic} may be filtered using a filter adapted to an infrasonic frequency range of part of this frequency range. According to the frequency range and the properties of the microphone 10, a low-pass or a band-pass filter may be used for extraction of the infrasonic signals. Both the low-pass filter characteristic and the band-pass filter characteristic may have to be limited to the desired infrasonic frequency range. The filtering of the audio signals V_{mic} may yield to the infrasonic signals V_{infra}.

In an operation S2.2 the yielded infrasonic signals V_{infra} may be averaged. A suitable and preferable averaging of the infrasonic signals V_{infra} may be a root mean square averaging which yields to root means square infrasonic signals V_{RMS}.

In an operation S2.3 an infrasonic level signal Vₗᵢₘᵢₜ is determined from the root mean square infrasonic signal V_{RMS} by employing the continuous level adjustment as described above in detail. An additional offset value, herein a signal-to-noise ratio (SNR) 20 may be provided to the continuous level adjustment of operation S2.3 to adapt the infrasonic level signal Vₗᵢₘᵢₜ to the working conditions of the signal processing device 100, especially the sensitivity of the infrasonic signal evaluation.

In an operation S2.4 the root mean square infrasonic signals V_{RMS} may be compared with the infrasonic level signal Vₗᵢₘᵢₜ determined from the root mean square infrasonic signals V_{RMS} and the offset SNR 20. If the root mean square infrasonic signals V_{RMS} is grater than the infrasonic level signal Vₗᵢₘᵢₜ a trigger signal 30 is generated. The trigger signal 30 may indicate that an infrasonic signal has passed a threshold value defined by the infrasonic level signal Vₗᵢₘᵢₜ. Further, the trigger signal 30 may be employed for triggering further provided internal or external components which are responsive on this trigger signal 30. For example, the trigger signal may be used to initiate an alarm of an alarm system.

An embodiment comprising microphone 10, evaluation unit 110 and trigger 30 may allow to set up an independent device for evaluating infrasonic signals. The provided trigger signal may be connected to further devices, such as alarm system, which may response suitable on the trigger signal. The embodiment of the invention according to FIG. 4 may be realised as an electronic circuit. Preferably, a digital signal processing (DSP) unit may comprise a software tool or an executable code section for carrying out the operations. The utilisation of a DSP unit may need an analog-to-digital converter (ADC) for receiving the analog signals of a microphone and providing a corresponding digital signal.

It may also be possible, that the device 100 may comprise additional units since the microphone 10 may be adapted to audio frequencies and infrasonic frequencies. The detected and obtained audio frequencies may be processed in an additional unit 120. It may be noted that the unit 120 may constitute an arbitrary number of units for processing signals obtained by the microphone. A plurality of devices may be appropriate to comprise a plurality of units processing audio and infrasonic signals which are obtained by a single adapted microphone. Preferably, the audio processing device may be a voice or speech processing device, respectively. Further it may be possible that the built-in microphone is not adapted to obtain infrasonic signals. Since microphones adapted to audio frequencies and infrasonic frequencies with an appropriate sensitivity are available and the exchange of the built-in microphone may be carried out easily.

Mobile phones and especially built-in phones in motor vehicles may provide the possibility to include a unit for evaluating infrasonic signals for monitoring spaces, especially spacious interior of a motor vehicle and to serve as alarm system. Usually, mobile phones comprise a digital signal processing (DSP) unit for processing voice or speech audio signals, respectively. This DSP unit may comprise additional a software tool or a code section according to an embodiment of the invention for evaluating the infrasonic signals. Moreover, in case of employing a mobile or built-in phone for monitoring the phone may generate a message which may be transmitted to the respective owner, to a security service provider, to the police or the like in response to a trigger signal generated by the infrasonic evaluation. The message may be a short message service (SMS) message according to the GSM standard for mobile communication. According messages services are provided by other mobile communication systems like UMTS, WCDMA, DCS etc.

Further, the phone may automatically call a pre-defined number to transmit a voice message or to enable the receiver of the call to listen to the occurrences which initiated the trigger signal of the infrasonic evaluation, for example enable the receiver to decide if the infrasonic evaluation initiated a false or a reliable alarm.

It may be noted that mobile or built-in phones of motor vehicles may only an example for the implementation of the infrasonic evaluation. In the future devices especially devices integrated in motor vehicles may be controlled by voice or speech commands, such as voice controlled phones, radio receivers, navigation systems, air conditioning systems and likely user controlled equipment. This method of controlling electrical devices provide a secure and simple controlling method. All this voice and speech controlled devices require an audio signal detector, for example a microphone, and an audio signal processing unit. These voice and speech controlled devices may provide the possibility to implement an infrasonic evaluating unit according to an embodiment of the invention.

Nevertheless, also further processing devices may implement the method for evaluating infrasonic signals. For example standard computers or mobile terminal devices comprising or connected to a microphone able for or adapted to detect infrasonic signals may be used for evaluating according to an embodiment of the invention.

The following figures present embodiments of the present invention included in a phone for mobile communication. The phone may be a mobile phone or a built-in mobile phone in a motor vehicle. According to the description above embodiments may be also included in further voice controlled and voice processing devices but which may be not limiting.

FIG. 5 shows an implementation of the infra-sound detection device within a digital signal processor of a mobile phone with respect to an embodiment of the invention. A microphone 10 adapted to voice audio and infrasonic audio may detect the signals. A pre-amplifier 11 may amplify the signals and an analog-to-digital converter (ADC) 12 may convert the microphone detected signals to digital signals which may be processed by a digital signal processing unit 200. According to the embodiment of the invention the microphone signal may be passed to voice audio processing and to infrasonic audio processing. The digital signal processing unit 200 may provide different signals thereof, an alarm trigger 30.1 generated by. the infrasonic evaluating process and a speech audio signal 40. The alarm trigger 30.1 may be used to trigger further units responsive in an appropriate way thereto. The speech audio signal 40 may be passed to the further units operating speech audio signal 40 in a mobile phone, like the transmitting unit.

In an operation S3.1 the infrasonic signal V_{infra} may be extracted from the microphone signal V_{mic} by employing a band-pass filter limited to the desired infrasonic frequency range.

The following operations are described above and shortened repeated.

In an operation S2.2 a root mean square averaging of the infrasonic signal V_{infra} yields to a root mean square signal V_{RMS}.

In an operation S2.3 the continuous level adjustment yields to the infrasonic level signal Vₗᵢₘᵢₜ. A signal-to-noise ratio SNR 20 may be provided to the continuous level adjustment to adapt the sensitivity of the infrasonic evaluation.

In an operation S2.4 the root mean square infrasonic signal and the infrasonic level signal may be compared yielding to a trigger signal. The trigger signal may be a signal providing two trigger levels. A first trigger level may indicate that the root mean square V_{RMS} is greater than the determined infrasonic level signal Vₗᵢₘᵢₜ and a second trigger level may indicate the corresponding other case of the signal comparison. A trigger signal able to comprise two signal levels is indicated in FIG. 5 by a trigger signal denoted as alarm trigger as “true” 30.1 or by a trigger signal denoted as alarm trigger as “false” 30.2.

The voice audio signals may be operated simultaneously in operations S3.5 and S3.6.

In a operation 3.5 the microphone signal V_{mic} may be filtered using a high-pass filter. The high-pass filter may be limited to a desired part of the voice frequency. The filtering may yield to a voice signal V_{voice}.

In an operation S3.6 the voice signal may be further filtered and processed according to the needs of the signal processing for mobile communication systems. This processing methods and operations are out of the scope of the present invention.

The above described implementation of the operating steps using a digital signal processor may not be limiting. It may also be possible that the operations are carried out by a different processing device. Further an electronic circuit may also enable the processing of the operations in a comparable and appropriate way.

According to an embodiment of the invention only few modifications may have to be carried out to implement the infrasonic evaluation process within a mobile phone of state of the art. Correspondingly, a motor vehicle built-in phone may be designed comparable to a mobile phone and therefore the description may be also related to this phone types.

FIG. 6 shows a mobile phone with implemented infra-sound detection according to an embodiment of the invention. The mobile phone 300 may comprise a microphone 10, a pre-amplifier 11, an analog-to-digital converter (ADC) 11 and a digital signal processing unit (DSP) 12. Further a user input/output unit 5.10, comprising a keyboard and a display, may be connected to a core electronic 5.9 for providing input commands of the user to the core electronic 5.9 and outputting signals and messages to inform the user. Further the core electronic 5.9 may provide a transmission signal (TX) due to the functions of the mobile phone which may be amplified by amplifier 5.1 and passed to the antenna 5.11 though a signal coupler 5.1. Received signals (RX) by the antenna 5.11 may be passed through the signal coupler 5.2 and amplified by amplifier 5.3 to the core electronic 5.9. Audio signals, like voice signals generated from the received signals may be passed from the core electronic 5.9 through an amplifier 5.4 to an ear speaker 5.7. Additionally, a buzzer 5.8 may be connected to the core electronic 5.9 through a driver 5.5 to generate indicating audio signals. The DSP unit 200 may provide voice signals and a trigger signal to the core electronic 5.9. The core electronic 5.9 may also provide a signal-to-noise ratio SNR value to the DSP 200 unit.

Additionally, an optional interface 5.6 may be implemented in the mobile phone 300. The interface 5.6 may receive the trigger from the core electronic 5.9 and may exchange further messages (msg) with the core electronic 5.9. The interface may also provide interface connectors 5.61 and 5.62. The interface connector 5.61 may be a relay input/output connector and the interface connector 5.62 may be a controlling bus connector. for example to plug on a CAN bus system. The connectors may enable to control or to transmit a control command to an external or central alarm system.

The microphone may be adapted to detect infrasonic signals and voice audio signals. The DSP unit 200 may provide the signal processing for the voice signals as also the signal evaluation of the infrasonic signals. Such an implementation according to an embodiment of the invention of a DSP unit is described above with respect to FIG. 5. The SNR value may be provided by the core electronic enabling the user of the mobile phone to adapt this SNR value to the operating conditions of the infrasonic signal evaluation.

According to the trigger provided to the core electronic a plurality of functions and operations may be initiated. A mobile or built-in phone for monitoring the phone may generate a voice or text message which may be transmitted to the respective owner, to a security service provider, to the police or the like in response to a trigger signal generated by the infrasonic evaluation. The message may be a short message service (SMS) message according to the GSM standard for mobile communication. According messages services are provided by other mobile communication systems like UMTS, WCDMA, DCS etc. Further, the phone may automatically call a pre-defined number to transmit a voice message or to enable the receiver of the call to listen to the occurrences which initiated the trigger signal of the infrasonic evaluation, for example let the receiver decide if the infrasonic evaluation initiated a false or a reliable alarm.

Since an approximately position of radio frequency phone operation according to a mobile communication system may be determined by the provider of the mobile communication services or another authorised provider of this service the determination of the current position of the mobile phone may be initiated. The initiation of the determination of the position may be initiated by transmitting a special message of the mobile phone due to the trigger signal to a provider 5.15.

It may be noted, that the implementation of an embodiment according to this invention within an audio or voice processing device may be carried out by slightly few modifications and additions.

It is to be understood that the above described embodiment of the invention is illustrative only, and that modifications thereof may occur to those skilled in the art. Accordingly, this invention is not to be regarded to be the embodiment disclosed herein, but is to be limited only as defined by the appended claims.

1. Method for monitoring an environment by evaluating an infrasonic signal obtained from said environment, comprising:
averaging said infrasonic signal (V_{infra}) to provide an averaged infrasonic signal (Vₐᵥ),
mapping said averaged infrasonic signal (Vₐᵥ) according to a function to provide an infrasonic noise signal (Vₙₒᵢₛₑ),
averaging said infrasonic noise signal (Vₙₒᵢₛₑ) to provide an averaged infrasonic noise signal (V_{av noise}),
offsetting said averaged infrasonic noise signal (V_{av noise}) with an offset value to provide an infrasonic level signal (Vₗᵢₘᵢₜ),
comparing said infrasonic level signal (Vₗᵢₘᵢₜ) with said averaged infrasonic signal (Vₐᵥ) and
generating a trigger signal (30) if said averaged infrasonic signal (Vₐᵥ) is greater than said infrasonic level signal (Vₗᵢₘᵢₜ).

2. Method according to clam 1, wherein a signal is filtered through a filter (S2.1, S3.1) to provide said infrasonic signal (V_{infra}) and wherein a filter characteristic is limited to an infrasonic frequency range.

3. Method according to claim 1, wherein said averaging of infrasonic signal to provide an averaged infrasonic signal is a root mean square averaging (S2.2).

4. Method according to claim 1, wherein said function is additionally rated with said averaged infrasonic noise signal (V_{av noise}) to provide said infrasonic noise signal (Vₙₒᵢₛₑ).

5. Method according to claim 1, wherein said function is a non-linear function (NLF).

6. Method according to claim 1, wherein said function maps a result of a combination of said averaged infrasonic signal (Vₐᵥ) and said averaged infrasonic noise signal (V_{av noise}) to provide said infrasonic noise signal(Vₙₒᵢₛₑ).

7. Method according to claim 1, wherein said function maps a result of a division of said averaged infrasonic signal (Vₐᵥ)and said averaged infrasonic noise signal (V_{av noise}) to provide said infrasonic noise signal (Vₙₒᵢₛₑ).

8. Method according to claim 1, wherein said function maps a result of a division of said averaged infrasonic signal (Vₐᵥ) and said averaged infrasonic noise signal (V_{av noise}) and a result of said function is multiplied with said averaged infrasonic noise signal (V_{av noise}) to provide said infrasonic noise signal (Vₙₒᵢₛₑ).

9. Method according to claim 1, wherein said offset value is an absolute offset value.

10. Method according to claim 1, wherein said offset value is a relative offset value, wherein said relative offset value (20) is relative to said averaged infrasonic noise signal.

11. Method according to claim 1, wherein said offset value is a multiplied averaged infrasonic noise signal (V_{av noise}) for rating said averaged infrasonic noise signal (V_{av noise}) to provide said infrasonic level signal (Vₗᵢₘᵢₜ).

12. Method according to claim 1, wherein said offset value is adjustable.

13. Software tool for monitoring an environment by evaluating an infrasonic signal, comprising program code portions for carrying out the operations of anyone of claim 1 to 12 when said program is implemented in a computer program.

14. Computer program for monitoring an environment by evaluating an infrasonic signal, comprising program code portions for carrying out the operations of anyone of claim 1 to 12 when said program is executed on a computer, a processing device or a digital signal processor.

15. Computer program product for monitoring an environment by evaluating an infrasonic signal, comprising program code portions stored on a computer readable medium for carrying out the operations of anyone of claims 1 to 12 when said program product is executed on a computer, a processing device or a digital signal processor.

16. Module for monitoring an environment by evaluating an infrasonic signal, comprising:
a first averaging component for averaging said infrasonic signal (V_{infra}) to provide an averaged infrasonic signal (Vₐᵥ),
a mapping component for mapping said averaged infrasonic signal (Vₐᵥ) according to a function to provide an infrasonic noise signal (Vₙₒᵢₛₑ),
a second averaging component for averaging said infrasonic noise signal (Vₙₒᵢₛₑ) to provide an averaged infrasonic noise signal (V_{av noise}),
an offsetting component for offsetting said averaged infrasonic noise signal (V_{av noise}) with an offset value to provide an infrasonic level signal (Vₗᵢₘᵢₜ),
a comparing component for comparing said infrasonic level signal (Vₗᵢₘᵢₜ) with said averaged infrasonic signal (Vₐᵥ) and
a generating component for generating a trigger signal if said averaged infrasonic signal (Vₐᵥ) is greater than said infrasonic level signal (Vₗᵢₘᵢₜ).

17. Module according to claim 16, comprising a filter component (S2.1, S3.1) for filtering a signal to provide said infrasonic signal (V_{infra}) and wherein said filter characteristic is limited to an infrasonic frequency range.

18. Module according to claim 16, wherein said first averaging component is a root mean square averaging component (S2.2).

19. Module according to claim 16, wherein said mapping component comprises additionally a rating component for rating said function with said averaged infrasonic noise signal (V_{av noise}) to provide said infrasonic noise signal (Vₙₒᵢₛₑ).

20. Device for monitoring an environment by evaluating an infrasonic signal, comprising:
a detector (10) to detect sound waves adapted to a frequency range including an infrasonic frequency range,
components responsive to a trigger signal (30, 30.1, 30.2) and
a processing unit (200),
wherein said processing unit carries out the operations of a method of a surveillance system for monitoring by evaluating an infrasonic signal according to anyone of the claims 1 to 12 and wherein said trigger signal is generated according to said method.

21. Device according to claim 20, wherein said detector is a microphone (10).

22. Device according to claim 21, wherein said microphone (10) is adapted to detect infrasonic signals and voice/speech audio signals.

23. Device according to claim 20, wherein said device is a radio frequency phone (300) operating according to a mobile communication system

24. Device according to claim 20, wherein said device is a voice/speech controlled device.

25. Surveillance system for monitoring an environment by evaluating an infrasonic signal, comprising:
a module (100) for monitoring by evaluating an infrasonic signal according to anyone of the claims 16 to 19 and
a device (300) processing voice/speech audio and infrasonic signals comprising:
a detector to detect sound waves adapted to a frequency range including an infrasonic frequency range and
components (5.9, 5.6, 5.61, 5.62) responsive to a trigger signal,
wherein said trigger signal is generated by said module.

26. System according to claim 25, wherein said detector is a microphone (10).

27. System according to claim 25, wherein said microphone (10) is adapted to detect infrasonic signals and voice/speech audio signals.

28. System according to anyone of the claims 25 to 27 wherein said device is a radio frequency phone (300) operating according to a mobile communication system

29. System according to claim 25, wherein said device is a voice/speech controlled device.
